(19) United States
(12) Patent Application Publication
(10) Pub. No.: US 2023/0400261 A1
(43) Pub. Date: Dec. 14, 2023

(54) NI-TI-BASED ALLOY, HEAT-ABSORBING/GENERATING MATERIAL, NI-TI-BASED ALLOY PRODUCTION METHOD, AND HEAT EXCHANGE DEVICE

(71) Applicant: Panasonic Intellectual Property Management Co., Ltd., Osaka (JP)

(72) Inventors: Yoshitaka NAKAMURA, Osaka (JP); Kotaro ONO, Osaka (JP); Tatsuya NAKAMURA, Osaka (JP); Kentaro SHII, Osaka (JP)

(21) Appl. No.: 18/250,315

(22) PCT Filed: Nov. 8, 2021
(86) PCT No.: PCT/JP2021/041031

§ 371 Date: Apr. 24, 2023

(30) Foreign Application Priority Data
Nov. 13, 2020 (JP) 2020-189704
Jul. 8, 2021 (JP) 2021-113700

(51) Int. Cl. F28D 20/00; F28F 21/08; C22C 19/00; C22C 19/03; C22C 14/00

(52) U.S. Cl. CPC F28D 20/0056; F28F 21/086; F28F 21/087; C22C 19/007; C22C 19/03; C22C 14/00

(57) ABSTRACT

A Ni—Ti-based alloy contains a Ni atom, a Ti atom, and a Si atom. The Ni—Ti-based alloy has a heat-absorbing/generating property.

### CROSS-REFERENCE OF RELATED APPLICATIONS

This application is the U.S. National Phase under 35 U.S.C. § 371 of International Patent Application No. PCT/JP2021/041031, filed on Nov. 8, 2021, which in turn claims the benefit of Japanese Patent Application No. 2020-189704, filed on Nov. 13, 2020, and Japanese Patent Application No. 2021-113700, filed on Jul. 8, 2021, the entire disclosures of which Applications are incorporated by reference herein.

### TECHNICAL FIELD

The present disclosure relates to Ni—Ti-based alloys, heat-absorbing/generating materials, Ni—Ti-based alloy production methods, and heat exchange devices. The present disclosure specifically relates to a Ni—Ti-based alloy containing a Ni atom and a Ti atom, a heat-absorbing/generating material made of the Ni—Ti-based alloy, the Ni—Ti-based alloy production method, and a heat exchange device including a heat-absorbing/generating member produced from the heat-absorbing/generating material.

### BACKGROUND ART

It is conventionally known that the Ni—Ti alloy has a shape-memory effect and exhibits superelasticity (also called pseudoelasticity). The superelasticity is a shape-memory property that after a Ni—Ti alloy is deformed by applying a stress at a temperature higher than or equal to an Af temperature, the Ni—Ti alloy returns to its initial shape once the stress is relieved. The Af temperature is a temperature at which transformation of an austenite phase which is a high-temperature phase into a martensite phase is completed.

It is also known that the Ni—Ti alloy can exhibit an elastocaloric effect (e.g., Non-Patent Literature 1). The elastocaloric effect is an effect that when a crystal structure and/or a magnetic structure changes in response to a change in stress caused due to loading and unloading of a load, heat corresponding to an entropy difference before and after the change is generated or absorbed.

Meanwhile, as a Ni—Ti-based alloy alternative to the Ni—Ti alloy, an alloy in which some of Ni atoms or Ti atoms are substituted with, for example, Cu atoms, Fe atoms, or Cr atoms also makes progress in development. It is known that the substituted Ni—Ti-based alloy has an excellent shape-memory property as compared with the Ni—Ti alloy. For example, Patent Literature 1 discloses a Ni—Ti-based alloy in which less than or equal to 5 at % of Ni and/or Ti are substituted with one type of element or two or more types of elements selected from the group consisting of Fe, Cr, Co, V, Al, Mo, W, Zr, and Nb. The Ni—Ti-based alloy shows a superelasticity effect that 2% strain arising from stress within a use environment temperature range can be made such that residual strain in the case of loading and unloading is less than or equal to 0.25%.

### CITATION LIST

### Non-Patent Literature

Non Patent Literature 1: J. Cui, Y. Wu, J. Muehlbauer, Y. Hwang, R. Radermacher, S. Fackler, M. Wuttig, and I. Takeuchi, Appl. Phys. Lett., 101,073904 (2012).

### Patent Literature

Patent Literature 1: JP 2007-51339 A

### SUMMARY OF INVENTION

A Ni—Ti-based alloy according to an aspect of the present disclosure contains an Ni atom, a Ti atom, and a Si atom. The Ni—Ti-based alloy has a heat-absorbing/generating property.

A heat-absorbing/generating material according to an aspect of the present disclosure contains the Ni—Ti-based alloy.

A Ni—Ti alloy production method according to an aspect of the present disclosure includes a mixing step and an arc discharge step. The mixing step includes mixing Ni powder, Ti powder, and Si powder together to obtain a mixture. The arc discharge step includes exposing the mixture to an arc discharge under an inert gas atmosphere.

A heat exchange device according to an aspect of the present disclosure includes a heat-absorbing/generating member and a housing member configured to house the heat-absorbing/generating member. The heat-absorbing/generating member includes the heat-absorbing/generating material.

### BRIEF DESCRIPTION OF DRAWINGS

FIG. 1A is a view of an example of a relationship between stress and strain of a Ni—Ti-based alloy according to embodiments;

FIG. 1B is a view of an example of thermal behavior of the Ni—Ti-based alloy according to the embodiments in response to a temperature change;

FIG. 2A is a conceptual view of a relationship between stress and strain in a conventional Ni—Ti alloy;

FIG. 2B is a conceptual view of thermal behavior of the conventional Ni—Ti alloy in response to a temperature change;

FIG. 3A is a view of a relationship between stress and strain in a Ni—Ti alloy (Comparative Example 1);

FIG. 3B is a view of thermal behavior of the Ni—Ti alloy (Comparative Example 1) in response to a temperature change;

FIGS. 4A and 4B are ternary graphs of an example of a composition ratio of Ni, Ti, and Si atoms in the Ni—Ti-based alloy according to the embodiments;

FIGS. 5A and 5B are ternary graphs of an example of a composition ratio of Ni, Ti, and Si atoms in the Ni—Ti-based alloy according to the embodiments;

FIG. 6A is a ternary graph of an example of a composition ratio of Ni, Ti, and Si atoms in the Ni—Ti-based alloy according to the embodiments;

FIG. 6B is an enlarged view of part of the ternary graph of FIG. 6A;

FIG. 7A is a schematic view of a heat-absorbing/generating material of a first embodiment;

FIG. 7B is a schematic view of a heat-absorbing/generating material of a second embodiment;

FIG. 7C is a schematic view of a heat-absorbing/generating material of a third embodiment;

FIG. 8A is a schematic view of an example of a heat exchange device according to the embodiments;

FIG. 8B is a schematic view of an example in which the heat exchange device of FIG. 8A is loaded;

FIG. 8C is a schematic view of an example in which the heat exchange device of FIG. 8A is tensioned;

FIGS. 9A to 9D are views of DSC curves of Ni—Ti—Si alloys of Examples 1 to 4;

FIGS. 10A to 10D are views of DSC curves of Ni—Ti—Si alloys of Examples 5 to 8;

FIGS. 11A to 11D are views of DSC curves of Ni—Ti—Si alloys of Examples 9 to 12;

FIGS. 12A to 12D are views of DSC curves of Ni—Ti—Si alloys of Examples 13 to 16;

FIGS. 13A to 13D are views of DSC curves of Ni—Ti—Si alloys of Examples 17 to 20;

FIGS. 14A to 14D are views of DSC curves of Ni—Ti—Si alloys of Examples 21 to 24;

FIGS. 15A to 15D are views of DSC curves of Ni—Ti—Si alloys of examples 25 to 28;

FIGS. 16A to 16B are views of DSC curves of Ni—Ti—Si alloys of Examples 29 to 30;

FIG. 17A is a view of an example of a relationship between stress and strain of the Ni—Ti-based alloy according to the embodiments; and

FIG. 17B is a view of an example of thermal behavior of the Ni—Ti-based alloy according to the embodiments in response to a temperature change.

### DESCRIPTION OF EMBODIMENTS

### (1) Overview

First of all, an overview of a Ni—Ti-based alloy will be described.

Patent Literature 1 (JP 2007-51339 A) discloses that a Ni—Ti-based alloy material exhibits a superelasticity effect, but Patent Literature 1 fails to discuss an elastocaloric effect, and therefore, the thermal behavior and the stress behavior of the Ni—Ti-based alloy have many unclarified aspects.

The inventors focused on the elastocaloric effect of an Ni—Ti alloy, independently proceeded with research and development, and found a new Ni—Ti-based alloy.

That is, the Ni—Ti-based alloy according to the present embodiments (hereinafter referred to as a “Ni—Ti—Si alloy”) contains Ni atoms, Ti atoms, and Si atoms. The Ni—Ti—Si alloy has a heat-absorbing/generating property. Note that in the present disclosure, the “Ni—Ti alloy” means an alloy including Ni atoms and Ti atoms. The Ni—Ti—Si alloy of the present embodiments has a structure in which at least either the Ni atoms or the Ti atoms in the Ni—Ti alloy are substituted with Si atoms.

As used in the present disclosure, the “heat-absorbing/generating property” means a property that heat absorption or heat generation occurs at the time of a phase transition. The “heat-absorbing/generating property” includes a property that heat absorption or heat generation occurs at the time of the phase transition along with a temperature change and a property that heat absorption or heat generation occurs at the time of a phase transition based on elasticity deformation. The Ni—Ti—Si alloy according to the present embodiments may undergo a structure change similar to that in the case of the Ni—Ti alloy, and therefore, when the Ni—Ti—Si alloy receives force, a phase transition occurs, and at the time of the phase transition, the Ni—Ti—Si alloy can absorb heat (heat absorption) from a surrounding environment or release heat (heat generation). That is, the Ni—Ti—Si alloy can exhibit the elastocaloric effect in response to a change in stress based on loading and unloading of a load. In the present disclosure, the elastocaloric effect means a phenomenon that when a substance elastically is deformed due to loading and unloading of a load and undergoes a phase transition, the substance generates or absorbs heat.

Moreover, the Ni—Ti—Si alloy of the present embodiments also has a heat-absorbing/generating property that the Ni—Ti—Si alloy undergoes a phase transition in response to a change in an environment temperature and accordingly generates and absorbs heat.

The Ni—Ti—Si alloy of the present embodiments contains the Si atoms and therefore has a heat-absorbing property and a heat-generating property which are different from these of the Ni—Ti alloy. Specifically, the Ni—Ti—Si alloy exhibits heat-absorbing/generating reaction at a temperature (phase transition temperature) different from that of the Ni—Ti alloy and further has a heating value and a heat absorbing value which are different from those of the Ni—Ti alloy. This is probably because substituting some of the Ni atoms or the Ti atoms in the conventional Ni—Ti alloy with the Si atoms changes bond energy between atoms in a crystal structure of the Ni—Ti—Si alloy.

Taking advantage of these properties enables the Ni—Ti—Si alloy to be appropriately used in a heat-absorbing/generating material and heat exchange devices having a heat exchanging functions, such as a heating device and a cooling device.

### (2) Details

The Ni—Ti—Si alloy, the heat-absorbing/generating material including an Ni—Ti—Si alloy material, and the heat exchange device according to the present embodiments will be described in detail below. Note that in the present specification and drawings, substantially the same components are denoted by the same reference signs, and the redundant description thereof will be omitted. Moreover, embodiments described below are mere examples of various embodiments of the present disclosure. That is, various modifications may be made to the following embodiments depending on design as long as the object of the present disclosure is achieved. [Ni—Ti—Si Alloy]

The Ni—Ti—Si alloy of the present embodiments contains Ni atoms, Ti atoms, and Si atoms. The Ni—Ti—Si alloy of the present embodiments is represented by NiₚTi_{q}Siᵣ, where the ratio of the number of the Ni atoms, the Ti atoms, and the Si atoms in the Ni—Ti—Si alloy is p:q:r. Here, p+q+r=1, 0<p<1, 0<q<1, and 0<r<1. In the NiₚTi_{q}Siᵣ, r is preferably less than or equal to 0.5. That is, the ratio of the number of the Si atoms to the total number of atoms in the Ni—Ti—Si alloy is preferably less than or equal to 0.5. In this case, the Ni—Ti—Si alloy can have a heat-absorbing/generating property different from that of the Ni—Ti alloy. Moreover, in this case, the Ni—Ti—Si alloy can have superelasticity different from that of the Ni—Ti alloy. Note that r being less than or equal to 0.5 means that Si is less than or equal to 50 at % in an atomic ratio descried later.

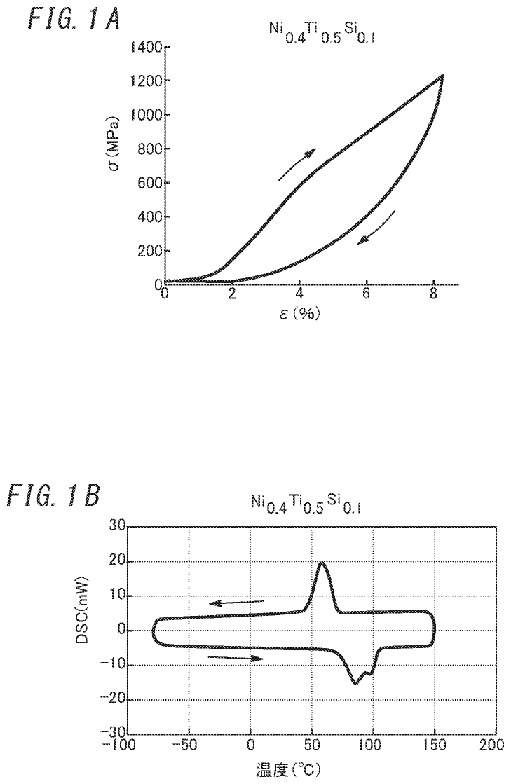

The Ni—Ti—Si alloy of the present embodiments has the heat-absorbing/generating property as already described. The Ni—Ti—Si alloy generates/absorbs heat on the basis of the phase transition along with a temperature change can be confirmed by measuring the heating value, for example, with a Differential Scanning Calorimetry (DSC) device. For example, as shown in FIG. 1B, a martensite phase of the crystal structure of the Ni—Ti—Si alloy reaches an austenite phase transformation start temperature (also referred to an As temperature) in the course of a temperature rising process, the Ni—Ti—Si alloy starts a phase transition (phase transformation) and thereby starts absorbing heat. Then, when the Ni—Ti—Si alloy reaches an austenite phase transformation end temperature (also referred to as an Af temperature), the transition to the austenite phase is completed. Moreover, when the austenite phase of the crystal structure of the Ni—Ti—Si alloy reaches a martensite phase transformation start temperature (also referred to as a Ms temperature) in the course of a temperature lowering process, the Ni—Ti—Si alloy starts a phase transformation and thereby starts generating heat. Then, when the Ni—Ti—Si alloy reaches a martensite phase transformation end temperature (also referred to as a Mf temperature), the transition to the martensite phase is completed. Thus, the Ni—Ti—Si alloy can absorb heat when its crystal structure is changed by heating, and the Ni—Ti—Si alloy can dissipate heat when its crystal structure is changed, by cooling, into a structure different from the crystal structure in the case of the heating.

Moreover, the Ni—Ti—Si alloy absorbs/generates heat on the basis of the phase transition along with elasticity deformation can be confirmed by comparing the stress-strain behavior due to loading and unloading of a load and the thermal behavior due to a temperature change of the Ni—Ti—Si alloy respectively with the stress-strain behavior and the thermal behavior of the Ni—Ti alloy.

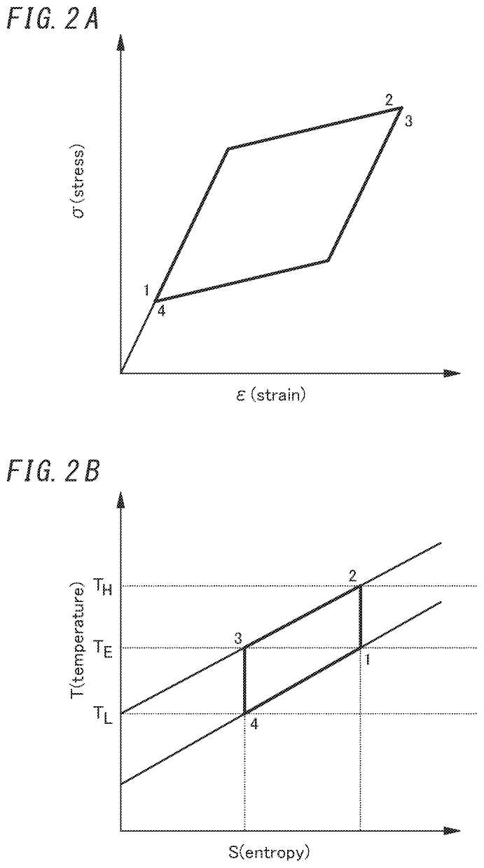

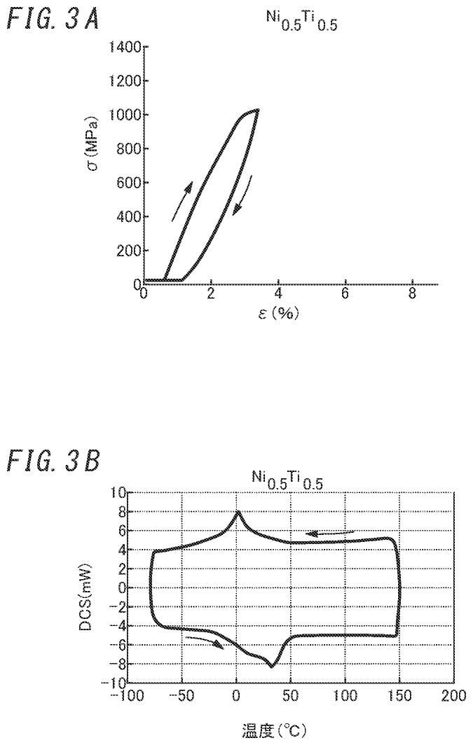

Here, the relationship between the stress-strain behavior and the thermal behavior of the Ni—Ti alloy and the heat-absorbing/generating property due to the elasticity deformation will be described with reference to FIGS. 2A, 2B, 3A, and 3B.

FIGS. 2A and 2B show a cooling cycle which shows an elastocaloric change in the Ni—Ti alloy under a heat insulation condition. FIG. 2A shows a curved line representing a relationship between stress and strain, and FIG. 2B shows an example of a curved line representing a relationship between a temperature and entropy. Numbers 1 to 4 shown in FIGS. 2A and 2B are numbers sequentially showing states 1 to 4 in a heat insulation cooling cycle and are common in FIGS. 2A and 2B.

In the state 1, the Ni—Ti alloy is under an ambient temperature T_{E} (environment temperature) and has an austenite-phase crystal structure. The Ni—Ti alloy in the state 1 has strain due to pressure applied, starts the phase transition from the austenite phase to the martensite phase, and causes heat generation reaction along with the phase transition, and thereby, the temperature increases (from the state 1 to the state 2). When the Ni—Ti alloy completes its phase transition to the martensite phase, the heat generation ends, and the temperature of the Ni—Ti alloy reaches T_{H}(high temperature) (state 2).

The Ni—Ti alloy in the state 2 dissipates heat (heat dissipation) to a surrounding environment (e.g., heat exchange medium) while maintaining the pressure (stress), and thereby, the temperature of the Ni—Ti alloy starts dropping and eventually reaches the temperature T_{E} (from state 2 to state 3). In the state 3, the Ni—Ti alloy is under an ambient temperature T_{E} (environment temperature) and has a martensite-phase crystal structure.

For the Ni—Ti alloy in the state 3, gradually releasing the pressure also gradually reduces the strain, and the Ni—Ti alloy starts the phase transition from the martensite phase to the austenite phase, causes heat absorption reaction along with the phase transition, and the temperature drops (from the state 3 to the state 4). When the Ni—Ti alloy completes the phase transition to the austenite phase, heat absorption ends, and the temperature of the Ni—Ti alloy reaches T_{L} (Low temperature) (state 4).

The Ni—Ti alloy in the state 4 absorbs heat (heat absorption) from the surrounding environment (e.g., heat exchange medium) while the pressure is released, and thereby, the temperature of the Ni—Ti alloy increases, and the Ni—Ti alloy returns to the state 1 in which the phase transition from the austenite phase to the martensite phase is started.

In this way, the Ni—Ti alloy can cause the phase transition induced by the stress along with a change in the stress due to loading and unloading, which confirms that the Ni—Ti alloy has a property that the Ni—Ti alloy absorbs/generates heat on the basis of the phase transition along with the elasticity deformation.

On the other hand, the Ni—Ti—Si alloy according to the present embodiments also exhibits stress-strain behavior similar to that of the Ni—Ti alloy as shown in FIG. 1A. Moreover, the Ni—Ti—Si alloy according to the present embodiments exhibits similar thermal behavior similar to that of the Ni—Ti alloy as shown in FIG. 1B. Therefore, the Ni—Ti—Si alloy can cause the phase transition induced by the stress along with a change in the stress due to loading and unloading. Thus, the Ni—Ti—Si alloy has a property that the Ni—Ti—Si alloy absorbs/generates heat on the basis of the phase transition along with the elasticity deformation. That is, the Ni—Ti—Si alloy is inferred to exhibit an elastocaloric effect similarly to the Ni—Ti alloy. Note that FIG. 1A is a view showing an example of a stress-strain (a-F) curved line of the Ni—Ti—Si alloy at a temperature of 110° C. FIG. 1B is a DSC curve showing thermal behavior of the Ni—Ti—Si alloy measured by using a DSC device under conditions that the rate of temperature rise is 10° C./min, the rate of temperature drop is 10° C./min, and the temperature range is from −80° C. to 150° C. Note that in the DSC curve, the ordinate depicts Heat Flow [mW], the abscissa depicts temperature [° C.].

Moreover, from the states 1 to 2 in FIG. 2A, the Ni—Ti alloy deformed by the strain caused by an applied load (loading) exhibits the shape-memory property that the strain gradually decreases by unloading in the states 3 to 4 and the Ni—Ti alloy gradually returns to its initial shape. In particular, when the Ni—Ti alloy returns to its initial shape simply by release of the pressure without heating, the Ni—Ti alloy has superelasticity. In the present disclosure, the shape-memory property means the property that also when application of a load (loading) causes deformation, releasing the load and then heating result in a recovery of an initial shape before the deformation. A superelasticity effect means the property that applying a load (loading) causes deformation and releasing the load (unloading) result in a recovery of an initial shape without heating.

The Ni—Ti—Si alloy easily obtains the shape-memory property and the superelasticity effect with respect to the stress based on loading and unloading of a load similarly to the Ni—Ti alloy. As described above, a conventional Ni—Ti alloy has increased strain along with increasing stress and, the strain gradually decreases as the stress decreases, for example, as shown in FIG. 3A, but the conventional Ni—Ti alloy does not return to its initial shape, and the strain may resides. The residual strain in the Ni—Ti alloy becomes significant when the size of strain of deformation by the load (stress) is large. Note that the Ni—Ti alloy has the shape-memory property that the residual strain is eliminated by heating and the Ni—Ti alloy returns to its initial shape (i.e., the strain is about 0%). In contrast, for example, as shown in FIG. 1A, as the load given to the Ni—Ti—Si alloy increases and the stress thus increases, the strain also gradually increases, but when the load is released and the stress is reduced, the strain gradually decreases, and the strain gradually becomes about 0%, so that the Ni—Ti—Si alloy returns to its initial shape. That is, the Ni—Ti—Si alloy easily obtains the superelasticity effect that giving a load (loading) causes deformation and then simply releasing the load (unloading) can make the Ni—Ti—Si alloy return to its initial shape without heating, or the like. Even when, for example, greater than or equal to 8% strain is caused as shown in FIG. 3A, the Ni—Ti—Si alloy easily obtains the superelasticity effect. This is probably because in the Ni—Ti—Si alloy, atoms are more likely to be displaced due to the occurrence of at least one or both of: substituting (substitution) of sites of the Ni atoms and the Ti atoms in the crystal structure of the Ni—Ti alloy with Si atoms; and entry (intrusion) of Si atoms into gaps each between a Ni atom and a Ti atom. Therefore, even when the Ni—Ti—Si alloy is more greatly deformed than the Ni—Ti alloy, the Ni—Ti—Si alloy can recover its initial shape and is thus readily applicable to a repeatedly usable material. In particular, when the Ni—Ti—Si alloy is deformed by loading at a temperature higher than or equal to Af and is then unloaded, the Ni—Ti—Si alloy easily obtains the superelasticity effect.

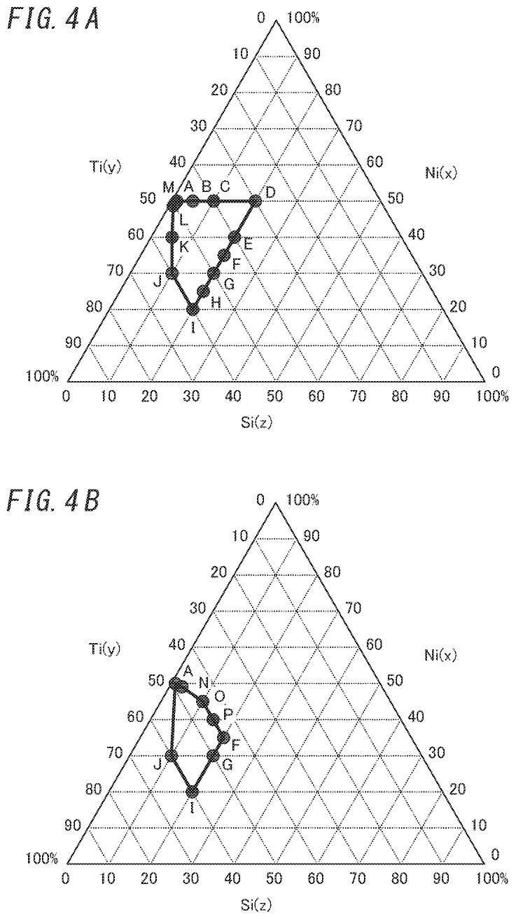

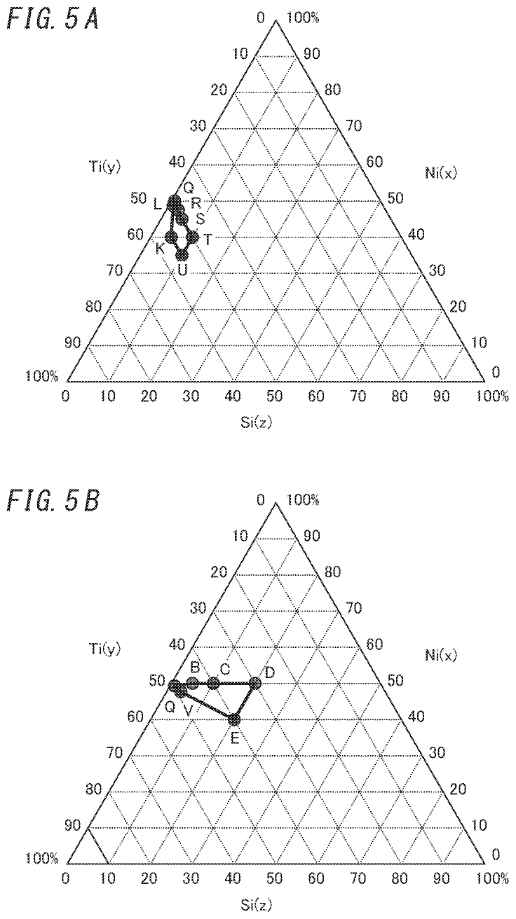

A more preferable composition of the Ni—Ti—Si alloy will be described with reference to ternary graphs (three component composition diagram) shown in FIGS. 4A to 5B. In the present disclosure, the ternary graphs each have the atom % of Ni atoms as the x axis, the atom % of Ti atoms as the y axis, and the atom % of Si atom as the z axis, that is, each are shown in the shape of a triangle, where the total number of atoms of the Ni—Ti—Si alloy is 100, atom composition percentages of the Ni atoms, the Ti atoms, and the Si atoms are respectively x, y, and z, and a point having coordinates (100, 0, 0), a point having coordinates (0, 100, 0), and a point having coordinates (0, 0, 100) on the xyz coordinate axes are vertices. In the ternary graphs, the atom composition percentages (x, y, z) are plotted within the range of the triangular shape including three sides connecting the three vertices, where the atomic ratio of Ni atoms is x [at %], the atomic ratio of Ti atoms is y [at %], and the atomic ratio of Si atoms is z [at %]. For example, a point having coordinates (30, 35, 35) shows that in the composition of the Ni—Ti—Si alloy, the atomic ratio of Ni is 30 at %, the atomic ratio of Ti is 35 at %, and the atomic ratio of Si is 35 at %. Moreover, a range surrounded by a plurality of line segments sequentially connecting a plurality of points in the ternary graph also includes a point on each of line segments (i.e., plurality of straight lines) connecting each point and its adjacent points.

As shown in FIG. 4A, the composition ratio of Ni atoms, Ti atoms, and Si atoms in the Ni—Ti—Si alloy is, in a ternary graph which shows the atom % of the Ni atoms on the x axis, the atom % of the Ti atoms on the y axis, and the atom % of the Si atoms on the z axis, preferably within a range surrounded by a line segment connecting a point A having coordinates (50, 49, 1) and a point D having coordinates (50, 30, 20), a line segment connecting the point D and a point I having coordinates (20, 60, 20), a line segment connecting the point I and a point J having coordinates (30, 60, 10), a line segment connecting the point J and a point K having coordinates (40, 55, 5), a line segment connecting the point K and a point L having coordinates (49, 50, 1), a line segment connecting the point L and a point M having coordinates (49.5, 49.5, 1), and a line segment connecting the point M and the point A. Note that from the point A to the point M and points on the line segments are included within the range surrounded by the line segments. In this case, a heat-absorbing/generating property different from that of the Ni—Ti alloy is exhibited. The composition ratio of the Ni atoms, the Ti atoms, and the Si atoms is, in the ternary graph which shows the atom % of the Ni atoms on the x axis, the atom % of the Ti atoms on the y axis, and the atom % of the Si atoms on the z axis, more preferably within a range surrounded by a line segment connecting the point A and a point C having coordinates (50, 40, 10), a line segment connecting the point C and a point E having coordinates (40, 40, 20), a line segment connecting the point E and the point I, the line segment connecting the point I and the point J, the line segment connecting the point J and the point K, the line segment connecting the point K and the point L, the line segment connecting the point L and the point M, and the line segment connecting the point M and the point A.

Note that in FIG. 4A, in the ternary graph which shows the atom % of the Ni atoms on the x axis, the atom % of the Ti atoms on the y axis, and the atom % of the Si atoms on the z axis, a point B having coordinates (50, 45, 5) and the point C having coordinates (50, 40, 10) are on a straight line connecting the point A and the point D. Moreover, the point E having coordinates (40, 40, 20), a point F having coordinates (35, 45, 20), a point G having coordinates (30, 50, 20), and a point H having coordinates (25, 55, 20) are on a straight line connecting the point D and the point I.

As shown in FIG. 4B, the composition ratio of the Ni atoms, the Ti atoms, and the Si atoms in the Ni—Ti—Si alloy is, in a ternary graph which shows the atom % of the Ni atoms on the x axis, the atom % of the Ti atoms on the y axis, and the atom % of the Si atoms on the z axis, much more preferably within a range surrounded by a line segment connecting a point A (50, 49, 1) and a point N having coordinates (49, 48, 3), a line segment connecting the point N and a point O having coordinates (45, 45, 10), a line segment connecting the point O and a point F having coordinates (35, 45, 20), a line segment connecting the point F and a point I represented by (20, 60, 20), a line segment connecting the point I and a point J having coordinates (30, 60, 10), and a line segment connecting the point J and the point A. In this case, the Ni—Ti—Si alloy can have a heating value higher than the heating value (about 11 J/g) of the Ni—Ti alloy. Thus, using the Ni—Ti—Si alloy as the heat-absorbing/generating material easily improves the efficiency of heat absorption/generation as compared with the Ni—Ti alloy.

Note that in FIG. 4B, in the ternary graph which shows the atom % of the Ni atoms on the x axis, the atom % of the Ti atoms on the y axis, and the atom % of the Si atoms on the z axis, a point P having coordinates (40, 45, 15) is on a straight line connecting the point O and the point F. Moreover, a point G having coordinates (30, 50, 20) is on a line segment connecting the point F and the point I.

As shown in FIG. 5A, the composition ratio of the Ni atoms, the Ti atoms, and the Si atoms in the Ni—Ti—Si alloy is, in a ternary graph which shows the atom % of the Ni atoms on the x axis, the atom % of the Ti atoms on the y axis, and the atom % of the Si atoms on the z axis, very much more preferably within a range surrounded by a line segment connecting a point Q having coordinates (49.5, 49.5, 1) and a point R having coordinates (47, 50, 3), a line segment connecting the point R and a point S having coordinates (45, 50, 5), and a line segment connecting the point S and a point T having coordinates (40, 50, 10), a line segment connecting the point T and a point U having coordinates (35, 55, 10), a line segment connecting the point U and a point K having coordinates (40, 55, 5), a line segment connected by the point K and a point L having coordinates (49, 50, 1), and a line segment connecting the point L and the point Q. In this case, a heating value much higher than the heating value (about 11 J/g) of the Ni—Ti alloy is obtained. Thus, using the Ni—Ti—Si alloy as the heat-absorbing/generating material more easily improves the efficiency of heat absorption/generation as compared with the Ni—Ti alloy.

As shown in FIG. 5B, the composition ratio of the Ni atoms, the Ti atoms, and the Si atoms in the Ni—Ti—Si alloy is, in a ternary graph which shows the atom % of the Ni atoms on the x axis, the atom % of the Ti atoms on the y axis, and the atom % of the Si atoms on the z axis, also preferably within a range surrounded by a line segment connecting a point Q having coordinates (49.5, 49.5, 1) and a point B having coordinates (50, 45, 5), a line segment connecting the point B and a point C having coordinates (50, 40, 10), a line segment connecting the point C and a point D having coordinates (50, 30, 20), a line segment connecting the point D and a point E having coordinates (40, 40, 20), a line segment connecting the point E and a point V having coordinates (48, 49, 3), and a line segment connecting the point V and the point Q. In this case, a heating value is less than the heating value (about 11 J/g) of the Ni—Ti alloy, but a low phase transition temperature (in particular, a low Af temperature) is easily obtained. Moreover, in this case, the Ni—Ti—Si alloy enables Ni metal and Ti metal as raw materials for the Ni—Ti alloy to be substituted with more cost-effective Si atoms and thus easily lowers manufacturing cost as compared with the Ni—Ti alloy.

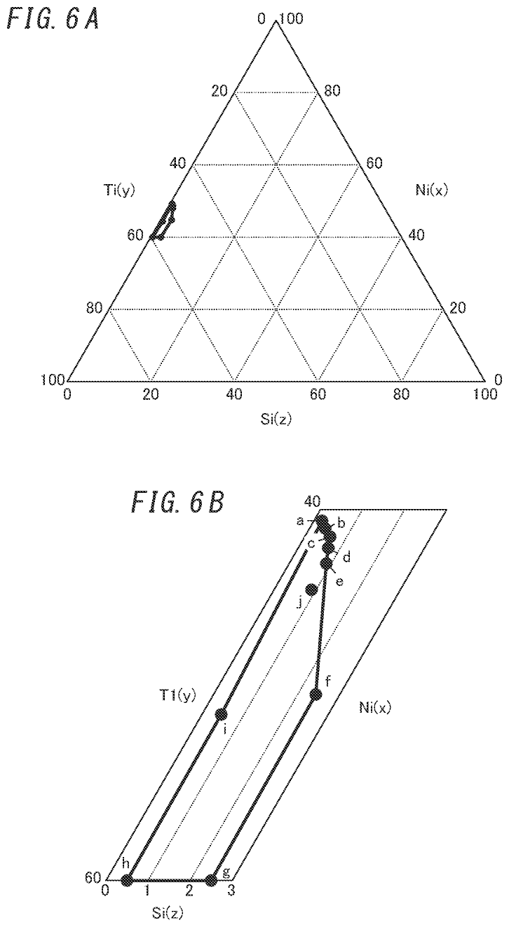

Moreover, as shown in FIGS. 6A and 6B, the composition ratio of the Ni atoms, the Ti atoms, and the Si atoms in the Ni—Ti—Si alloy is, in a ternary graph which shows the atom % of the Ni atoms on the x axis, the atom % of the Ti atoms on the y axis, and the atom % of the Si atoms on the z axis, preferably within a range surrounded by a line segment connecting a point a having coordinates (49.7, 50, 0.3) and a point b having coordinates (49.5, 50, 0.5), a line segment connecting the point b and a point c represented coordinates (49.3, 50, 0.7), a line segment connecting the point c and a point d having coordinates (49, 50.2, 0.8), a line segment connecting the point d and a point e having coordinates (48.5, 50, 5.1), a line segment connecting the point e and a point f having coordinates (45, 52.5, 2.5), a line segment connecting the point f and a point g having coordinates (40, 57.5, 2.5), a line segment connecting the point g and a point h having coordinates (40, 59.5, 0.5), a line segment connecting the point h and a point i having coordinates (44.5, 55, 0.5), and a line segment connecting the point i and the point a. Note that from the points a to i and points on the line segments are included within the range surrounded by the line segments. In this case, a heat-absorbing/generating property different from that of the Ni—Ti alloy is exhibited. Specifically, in this case, the Ni—Ti—Si alloy has a heating value higher than the heating value (about 11 J/g) of the Ni—Ti alloy. Thus, using the Ni—Ti—Si alloy as the heat-absorbing/generating material particularly easily improves the efficiency of heat absorption/generation as compared with the Ni—Ti alloy. A point j (48, 51, 1) is within the range surrounded by the line segments. FIG. 6B is an enlarged view of a portion shown in the shape of parallelogram formed by a line segment connecting Ti:40 at % and 60 at %, a line segment connecting Si:0 at % and 3 at %, and a line segment parallel to these line segments in the ternary graph of FIG. 6A.

[Production Method of Ni—Ti—Si Alloy]

A production method of the Ni—Ti—Si alloy in the present embodiments includes a mixing step and an arc discharge step. The mixing step includes mixing Ni powder, Ti powder, and Si powder together to obtain a mixture. The arc discharge step includes subjecting the mixture obtained in the mixing step to an arc discharge under an inert gas atmosphere. In this case, a Ni—Ti—Si alloy having an excellent elastocaloric effect and also having an excellent heat-absorbing/generating property is easily obtained. Moreover, according to the present production method, atoms which can be included in the Ni—Ti—Si alloy are easily uniformly mixed together as compared with a production method employing solid phase reaction. Moreover, the present production method enables the Ni—Ti—Si alloy to be synthesized in a further reduced time period and thus enables the production efficiency of the Ni—Ti—Si alloy to be improved.

The production method of the Ni—Ti—Si alloy of the present embodiments will be specifically described with reference to examples.

(Mixing Step)

First, metal nickel, metal titanium, and metal silicon are prepared. The metal nickel, the metal titanium, and the metal silicon are not particularly limited in terms of their nature but may each be in powder form. The metal nickel, the metal titanium, and the metal silicon are weighed at an intended composition ratio and are mixed together, thereby preparing a mixture. The mixture is pelletized at an appropriate pressure by using a forming die (8 mmφ), thereby obtaining pellets of the mixture. A pressure condition for the pelletization is, for example, 60 MPa. Note that a condition for the pelletization is not limited to this example but may accordingly be adjustable. Moreover, pelletizing in the mixing step is not an essential configuration, but the mixture in mixture state may be used in another step.

(Arc Discharge Step)

Subsequently, the mixture or pellets thus prepared are put in a vacuum chamber and are subjected to an arc discharge under an argon gas atmosphere and at a gas pressure set to about 0.1 MPa. Thus, the pellets, for example, are baked. A time period for which the mixture or pellets thus prepared are subjected to the arc discharge is at least accordingly adjusted and may be, for example, 10 seconds or longer. The sample thus baked is turned upside down and is further subjected to the arc discharge under a condition similar to the above-explained condition, thereby baking the sample. This process is repeated three to four times to obtain a baked product. Thus, the Ni—Ti—Si alloy is obtained. Note that the condition for the arc discharge step is not limited to the example described above. For example, the atmosphere may be an appropriate inert gas, and the gas pressure is also accordingly adjustable. In the arc discharge step, the number of times of baking is not limited to the example described above but may accordingly be adjusted.

(Heating And Baking Step)

The baked product thus obtained may be further heated and baked. For example, the baked product is put in a quartz tube, the quartz tube is evacuated to a degree of vacuum of 10-4 Pa and is vacuum sealed, and the quartz tube is put in a furnace and is heated under an atmosphere condition for 24 hours while the temperature of the furnace is about 900° C. After 24 hours has elapsed, the quartz tube is allowed to cool, and then, a product is taken out of the quartz tube. Thus, the Ni—Ti—Si alloy is obtained. Conditions for heating and cooling are not limited to the example described above, but a heating temperature, a heating time, a cooling temperature, and a cooling time are at least appropriately determined.

In the production method, the ratio of inevitable impurities other than the Ni atoms, Ti atoms, and Si atoms in the Ni—Ti—Si alloy can be 0.10% or less.

The composition of the Ni—Ti—Si alloy can be determined based on a peak and a peak area of a spectrum measured by using a Scanning Electron Microscope/Energy Dispersive X-ray Spectroscope (SEM/EDX). The structure of the Ni—Ti—Si alloy can be determined by a powder X-ray diffraction measuring method.

Note that the production method of the Ni—Ti—Si alloy is not limited to the method and steps described above but may include an appropriate method(s) and step(s) or the step(s) may be omitted as long as a Ni—Ti—Si alloy having a substantially the same composition can be produced. For example, alternatively to the arc discharge, heating may melt the pellets of the mixture, and then the mixture thus melted may be baked to produce the Ni—Ti—Si alloy.

[Heat-Absorbing/Generating Material]

The Ni—Ti—Si alloy described above is usable as a heat-absorbing/generating material 1. The heat-absorbing/generating material of the present embodiments contains the Ni—Ti—Si alloy. Note that the Ni—Ti—Si alloy may be used alone as the heat-absorbing/generating material 1.

The shape of the Ni—Ti—Si alloy in the heat-absorbing/generating material 1 is not particularly limited but may be, for example, a powder shape, a granular shape (particle shape), a block shape, a line shape (wire shape), a spherical shape, a polygonal prism shape, a cylindrical shape, or a porous shape. When the Ni—Ti—Si alloy in the heat-absorbing/generating material 1 has the powder shape, the granular shape, the block shape, or the porous shape, a contact area where a heat-absorbing/generating member 100 produced from the heat-absorbing/generating material 1 and a heat medium 120 contact with each other can be increased. Thus, the heat transmission of a heat exchange device 200 can be improved.

When the heat-absorbing/generating material 1 has, for example, the line shape, the heat-absorbing/generating material 1 may be processed to have a spring shape. When the heat-absorbing/generating material 1 has the spring shape, a load is easily given to the heat-absorbing/generating material 1 and is easily unloaded, and therefore, heat can be easily taken out of the heat-absorbing/generating material 1 and can be easily absorbed by the heat-absorbing/generating material 1.

The heat-absorbing/generating material 1 preferably further contains the Ni—Ti—Si alloy and a mixed component 2 mixed with the Ni—Ti—Si alloy. In this case, heat can be more easily taken out of the heat-absorbing/generating material 1 and can be easily absorbed by the heat-absorbing/generating material 1.

The mixed component 2 may be an appropriate material. The shape of the mixed component 2 is not particularly limited but can be processed into an appropriate shape or can be used without processing.

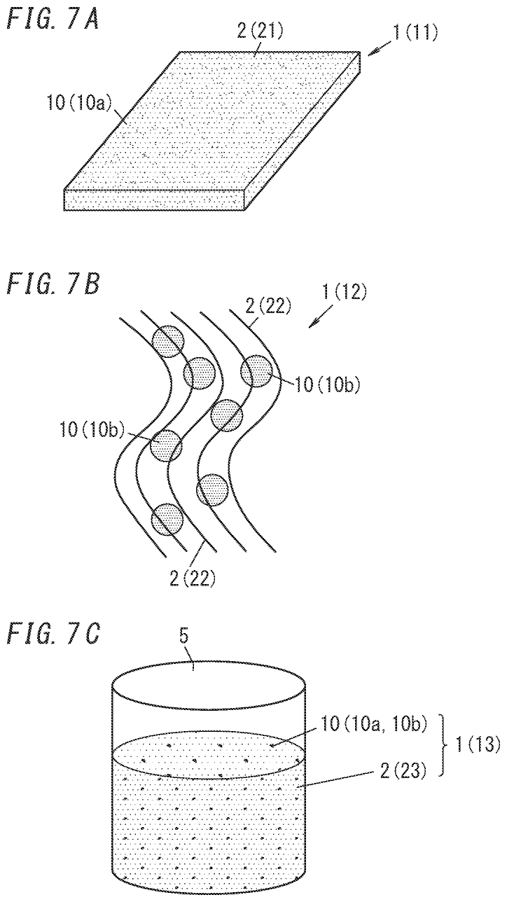

With reference to FIGS. 7A to 7C, more specific examples of the heat-absorbing/generating material 1 will be described below. Note that the aspect of the heat-absorbing/generating material 1 is not limited to the following aspects.

A heat-absorbing/generating material 1 (11) shown in FIG. 7A contains a Ni—Ti—Si alloy and a resin component 21 as a mixed component 2 mixed with the Ni—Ti—Si alloy. For example, the heat-absorbing/generating material 11 of the present embodiments includes powder 10 (10a) of the Ni—Ti—Si alloy dispersed in the resin component 21. Specifically, the heat-absorbing/generating material 11 is a molded body which is obtained by molding a mixture containing the powder 10a of the Ni—Ti—Si alloy and the resin component 21 into an appropriate shape.

The heat-absorbing/generating material 11 of the present embodiments contains the Ni—Ti—Si alloy and can thus absorb and generate heat on the basis of a change in stress caused by a load.

The resin component 21 may be one type or two or more types of appropriate resins. The resin component 21 includes an inorganic polymer such as an appropriate thermosetting resin, an appropriate thermoplastic resin, an appropriate photocurable resin, and an appropriate silicon resin. However, the resin component 21 is not limited to the example described above.

The heat-absorbing/generating material 11 may contain other components, for example, an appropriate additive, other than the Ni—Ti—Si alloy and the resin component 21.

The shape of the heat-absorbing/generating material 11 is not particularly limited but may be processed into an appropriate shape. For example, the heat-absorbing/generating material 11 may have a plate shape, a line shape (wire shape), a spring shape, or a spherical shape. When the heat-absorbing/generating material 11 has a thickness, the lower limit of the thickness is, for example, 10 μm. When the heat-absorbing/generating material 11 has a diameter, the lower limit of the diameter is, for example, 10 μm. Note that the Ni—Ti—Si alloy included in the heat-absorbing/generating material 11 of a first embodiment is not limited to being in the shape of the powder 10a but may be in particle shape (particle 10b) or in any of other shapes.

The heat-absorbing/generating material 1 (12) shown in FIG. 7B includes a mixed component 2 and particles 10 (10b) of a Ni—Ti—Si alloy, and the particles 10 (10b) are attached to the mixed component 2. More specifically, the mixed component 2 has a fiber-like shape, and to a surface or an interior of the mixed component 2 (22) in fiber shape, the particles 10b of the Ni—Ti—Si alloy are attached. The heat-absorbing/generating material 12 of the present embodiments also contains the Ni—Ti—Si alloy in a similar manner to the heat-absorbing/generating material 11 explained above and can thus have a property that absorbs and generates heat on the basis of a change in stress caused by a load. Moreover, also in this case, a contact area where a heat-absorbing/generating member 100 produced from the heat-absorbing/generating material 12 and a heat medium 120 and the like contact with each other can be increased. Thus, the heat transmission of a heat exchange device 200 can be improved.

A fibrous mixed component 22 is not particularly limited as long as it is a component molded into a fiber shape, and the fibrous mixed component 22 may be, for example, woven cloth or unwoven cloth. Moreover, the fibrous mixed component 22 may be, for example, the resin component 21 formed to have a fibrous shape and may be used as the mixed component 2 (22).

In FIG. 7B, the Ni—Ti—Si alloy is indicated as the particles 10b but is not limited to this example. As long as the Ni—Ti—Si alloy can be bonded to the mixed component 22 in fiber shape, it may be powder 10a or may be in any of other shapes.

A heat-absorbing/generating material 1 (13) shown in FIG. 7C includes: a mixed component 2 as a medium 23; and powder 10a or particles 10b of a Ni—Ti—Si alloy dispersed in the medium 23. The heat-absorbing/generating material 13 of the present embodiments also contains the Ni—Ti—Si alloy in a similar manner to the heat-absorbing/generating material 11 (12) and thus absorbs and generates heat on the basis of a change in stress caused by a load.

In FIG. 7C, a heat-absorbing/generating material 13 is housed in a container 5. Note that in FIG. 7C, the container 5 has a cylindrical shape, but this should not be construed as limiting. For example, the container 5 may be configured such that the medium 23 and the powder 10a are flowable therein. Note that in the heat-absorbing/generating material 13, the container 5 is not an essential configuration.

The medium 23 is not particularly limited but is, for example, a fluid. The fluid may be a liquid, a gas, or a mixture of the liquid and the gas. That is, the fluid includes at least one of the liquid or the gas. The fluid includes water, a solvent such as an organic solvent, a petroleum-derived liquid fuel, liquid fuel, hydraulic oil, and the like as the liquid, and includes, for example: air, nitrogen, oxygen, and argon, and a gas fuel such as methane, propane, acetylene, hydrogen, and a natural gas as the gas. Thus, the medium 23 includes at least one type of fluid selected from the group consisting of the liquids and the gases described above. In the heat-absorbing/generating material 13 shown in FIG. 7C, the medium 23 is in liquid form.

In the above description, examples in each of which the heat-absorbing/generating material 1 (11, 12, 13) made of the Ni—Ti—Si alloy is used alone has been described, but, application of the heat-absorbing/generating material 1 to the heat-absorbing/generating member 100 is not limited to these examples, and appropriate heat-absorbing/generating materials 1 in combination may be included in the heat-absorbing/generating member 100.

[Heat Exchange Device]

The Ni—Ti—Si alloy and the heat-absorbing/generating material 1 described above exhibits an elastocaloric effect as already described. Therefore, taking advantages of the elastocaloric effect of the heat-absorbing/generating material 1 resulting from a change in stress caused by a load, for example, by applying the load to the heat-absorbing/generating material 1 and removing the load from the heat-absorbing/generating material 1 enables a heat exchanging mechanism in the heat exchange device 200 to be implemented.

The heat exchange device 200 of the present embodiments includes the heat-absorbing/generating member 100 and a housing member 110 in which the heat-absorbing/generating member 100 is housed. The heat-absorbing/generating member 100 includes the heat-absorbing/generating material 1. The heat exchange device 200 enables heat to be exchanged between the heat medium 120 passing through the housing member 110 and the heat-absorbing/generating member 100. For example, in the heat exchange device 200, when the heat medium 120 moves in the housing member 110, heat generation or heat absorption by the heat-absorbing/generating member 100 disposed in the housing member 110 causes heat exchange between the heat medium 120 and the heat-absorbing/generating member 100. Thus, the temperature of the heat medium 120 increases or decreases compared with the temperature of the heat medium 120 before fed into the housing member 110, and in this state, the heat medium 120 is discharged from the housing member 110 in the heat exchange device to an outside.

The heat medium 120 can give and receive heat to and from the heat-absorbing/generating member 100. The heat medium 120 may be an appropriate heat medium or an appropriate cooling medium. The heat medium 120 includes at least one type of fluid selected from the group consisting of, for example, liquids and gases. Examples of the liquids include water, a solvent such as an organic solvent, a petroleum-derived liquid fuel, and hydraulic oil. Examples of the gases include air, nitrogen, oxygen, argon, and a gas fuel such as methane, propane, acetylene, hydrogen, and natural gas. Discharging the heat medium 120 from the heat exchange device 200 can increase or lower the temperature of a surrounding environment.

Regarding deformation of the heat-absorbing/generating member 100 in the heat exchange device 200, only the heat-absorbing/generating member 100 may be directly deformed, or the entirety of the housing member 110 may be deformed to indirectly deform the heat-absorbing/generating member 100. For example, for indirect deformation, the housing member 110 may be made of an elastic material, and when the entirety of the housing member 110 is elasticity deformed, the pressure in its interior changes to lower an inner pressure (adiabatic compression) or to increase the inner pressure (adiabatic expansion), thereby indirectly causing a change in stress in the heat-absorbing/generating member 100, which may deform the heat-absorbing/generating member 100.

As explained above, the heat-absorbing/generating member 100 can function as both a heating member and a cooling member, and therefore, the heat exchange device 200 can have one or both of, for example, a heating function and a cooling function. That is, the heat exchange device 200 can be one of or both of the heating device and the cooling device. The heating device applies pressure (strain) to the heat-absorbing/generating member 100 to cause the heat-absorbing/generating member 100 to generate heat and to cause the heat-absorbing/generating member 100 to transmit the heat to the heat medium 120. Thus, in the heating device, for example, the temperature of a surrounding environment or the temperature of the medium can be increased. The cooling device is provided with the heat-absorbing/generating member 100 deformed in advance, and to return the heat absorbing/generating member 100 to its initial shape, the heat-absorbing/generating member 100 is unloaded, and thereby, the heat-absorbing/generating member 100 absorbs heat from the heat medium 120. Thus, the cooling device can lower, for example, the temperature of a surrounding atmosphere or the temperature of the medium.

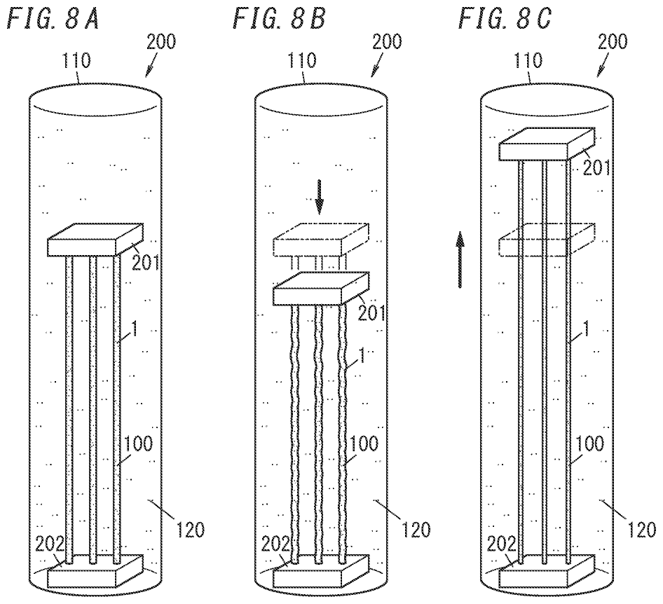

A more specific aspect of the heat exchange device 200 will be described with reference to FIGS. 8A to 8C.

A heat exchange device 200 in FIG. 8A includes a first support member 201, a second support member 202, and heat-absorbing/generating members 100. The heat-absorbing/generating members 100 lie between the first support member 201 and the second support member 202 and are configured to deform by receiving a load from at least one of the first support member 201 or the second support member 202.

The first support member 201 and the second support member 202 are members supporting the heat-absorbing/generating members 100. The first support member 201 and the second support member 202 gives a load based on a change in the stress of the heat-absorbing/generating members 100. The first support member 201 and the second support member 202 are not particularly limited as long as they can support the heat-absorbing/generating members 100, and the first support member 201 and the second support member 202 may be made of an appropriate material.

In FIG. 8A, in the heat exchange device 200, the housing member 110 houses the first support member 201, the second support member 202, and the heat-absorbing/generating members 100 lying between the first support member 201 and the second support member 202. Thus, the heat exchange device 200 shown in FIG. 8A can deform the heat-absorbing/generating members 100, for example, when one of the first support member 201 or the second support member 202 externally receives a load. When the heat-absorbing/generating members 100 receive the load and are thus deformed in shape, the heat-absorbing/generating members 100 generate or absorb heat in response to their deformation and can thus dissipate heat to, or absorb heat from, the heat medium 120 present around the heat-absorbing/generating members 100.

The heat-absorbing/generating members 100 each have a line shape (wire shape) in FIGS. 8A to 8C. The heat-absorbing/generating members 100 receive the load from at least one of the first support member 201 or the second support member 202, thereby shrinking or stretching to deform (see, for example, FIGS. 8B and 8C). Note that the configuration shown in FIG. 8A includes three wire-shaped heat-absorbing/generating members 100, but this should not be construed as limiting. The shape, the number, and the like of the wire-shaped heat-absorbing/generating members 100 may accordingly be adjusted.

The housing member 110 has a hollow circular column shape in FIGS. 8A to 8C, but this should not be construed as limiting. The appropriate shape, material, structure, and the like of the housing member 110 are not particularly limited as long as the housing member 110 can house the heat-absorbing/generating member(s) 100.

When the heat exchange device 200 is employed as the heating device, for example, heat exchange can be implemented as described below.

First of all, in the heat exchange device 200 in a state where no load is applied to the heat-absorbing/generating members 100 as shown in FIG. 8A, a load is applied to the first support member 201 as shown in FIG. 8B. This transmits the load to the heat-absorbing/generating members 100 lying between the first support member 201 and the second support member 202, thereby deforming the heat-absorbing/generating members 100.

The heat-absorbing/generating members 100 are deformed, and thereby, the heat-absorbing/generating members 100 generate heat and give the heat to the heat medium 120 passing through the housing member 110, which can increase the temperature of the heat medium 120. Thus, the heating mechanism is implemented. Note that the deformation of the heat-absorbing/generating members 100 is not limited to compression deformation as in FIG. 8B but may be dilation deformation as in FIG. 8C.

When the heat exchange device 200 is employed as the cooling device, heat exchange can be implemented, for example, as described below.

The heat-absorbing/generating members 100 are deformed from the state shown in FIG. 8A in advance, and heat generated during the deformation is removed, and in this state, the heat-absorbing/generating members 100 are then disposed in the housing member 110. In this state, the heat medium 120 is caused to pass through the housing member 110, thereby performing heat exchange between the heat medium 120 and the heat-absorbing/generating members 100. Specifically, as shown in FIG. 8B, a state where the heat-absorbing/generating members 100 are deformed by applying a load is an initial state, in which the heat medium 120 are caused to pass through the housing member 110. While the heat medium 120 passes through the housing member 110, the load to the heat-absorbing/generating members 100 is released, thereby gradually eliminating the strain of the heat-absorbing/generating members 100 so that the heat-absorbing/generating members 100 return to their initial shape. At this time, the heat-absorbing/generating members 100 absorb heat, thereby drawing heat from the heat medium 120. This can lower the temperature of the heat medium 120. In this way, the cooling mechanism can be implemented. Note that the deformation of the heat-absorbing/generating members 100 is not limited to the compression deformation as in FIG. 8B but may be dilation deformation as in FIG. 8C similarly to the above-explained heating mechanism. Heat generated by application of a load to, and consequently deformation of, the heat-absorbing/generating members 100 may be released to an outside of the heat exchange device 200 by providing, for example, an appropriate heat exhausting mechanism.

When the heat-absorbing/generating members 100 thus deformed gradually return to their initial shape and heat absorption is completed, the heat-absorbing/generating members 100 return to the state in FIG. 8A. Therefore, in order to perform heat exchange for heat absorption again, a load is applied to the heat-absorbing/generating members 100 to bring the heat-absorbing/generating members 100 into a deformed state, and then, the heat medium 120 is fed. Moreover, the heat-absorbing/generating members 100 generate heat when deformed, and therefore, when the heat medium 120 is not heated, the heat medium 120 is preferably removed from the housing member 110. The heat-absorbing/generating members 100 are deformed and are brought into the state shown in FIG. 8B in advance, and thereby, returning the heat-absorbing/generating members 100 thus deformed to their initial shape in the same order as that described above causes heat exchange between the heat medium 120 and the heat-absorbing/generating members 100, and the heat-absorbing/generating members 100 draw heat from the heat medium 120, thereby cooling the heat medium 120.

### Variations

The heat exchange device 200 may include an appropriate device (not shown). For example, the heat exchange device 200 may include a pressurizing device. The pressurizing device is, for example, a device configured to give a load to and/or release the load from (unload) the first support member 201 or the second support member 202 of the heat exchange device 200 or both the first support member 201 and the second support member 202. When the heat exchange device 200 includes a pressurizing device, the heat exchange device 200 can efficiently deform the heat-absorbing/generating members 100, and therefore, the heat exchange device 200 can more efficiently perform heat exchange to and from the heat medium 120. Note that the pressurizing device may be used to improve the flowability of the heat medium 120 flowing in the housing member 110 in the heat exchange device 200.

The heat exchange device 200 may include a plurality of flow paths connected to the housing member 110. Each of the flow paths has, for example, a length and has a tubular shape. The plurality of flow paths are usable, for example, as feed paths, discharge paths, and the like for the heat medium 120.

The housing member 110 in the heat exchange device 200 may be covered with a thermal insulating member. In this case, heat transferred to and from the outside of the heat exchange device 200 is reduced, and thus, the heat exchanging function can be increased. Examples

Hereinafter, the present disclosure will be described in further detail with reference to examples. Note that the present disclosure is not limited to the following examples, but various modifications may be made to the examples as long as the object of the present invention is achieved.

[Synthesis of Ni—Ti—Si Alloy]

Metal nickel powder (maximum particle size: 63 μm, purity: 99.9%), metal titanium powder (maximum particle size: 45 μm, purity: 99.9%), and metal silicon powder (maximum particle size: 45 μm, purity: 99.9%) were mixed together to achieve the ratios shown in Tables 1 and Table 2, thereby preparing mixtures (1.6 g to 2.0 g). Note that in Comparative Example 1, metal nickel powder (maximum particle size: 63 μm, purity: 99.9%) and metal titanium powder (maximum particle size: 45 μm, purity: 99.9%) were mixed together to achieve a ratio of 50 at %:50 at %, thereby preparing a mixture.

The mixtures thus prepared were pelletized by using a molding die (8 mmφ) under a pressure of 60 MPa, thereby obtaining pellets of the mixtures. Subsequently, the pellets were put in a vacuum chamber and were heated and baked for about 10 seconds while subjected to an arc discharge under an argon gas atmosphere and at a gas pressure set to about 0.1 MPa. The pellets thus baked were turned upside down and were further heated and baked while subjected to an arc discharge under a condition similar to the above condition. This process was repeated three to four times to obtain baked products, and then, the baked products were put in quartz tubes, and the quartz tubes were evacuated to a degree of vacuum of 10-4 Pa, were vacuum sealed, and were put in a furnace. The quartz tubes were heated for 24 hours in the furnace at a temperature of 900° C. and under an atmosphere condition. After 24 hours have elapsed, the quartz tubes were allowed to cool, and products were taken out of the quartz tubes.

In this way, the Ni—Ti—Si alloys having compositions shown in Tables 1 and 2 were obtained. The compositions of the Ni—Ti—Si alloys thus obtained were confirmed based on a peak and a peak area from a spectrum measured by using a Scanning Electron Microscope/Energy Dispersive X-ray Spectroscope (SEM/EDX). Moreover, the structures of the Ni—Ti—Si alloys thus obtained were determined by performing powder X-ray diffraction measurement and were martensite phases at a room temperature. Note that in the Ni—Ti—Si alloy of each example, the sum of inevitable impurity atoms was less than or equal to 0.1 at %.

[Evaluation of Ni—Ti—Si Alloys]

(DSC Measurement (Thermal Behavior))

Powder of the Ni—Ti—Si alloys (Example 1 to 30) thus obtained was caused to flow by using a DSC device (model number DSC7020 manufactured by Hitachi High-Tech Corporation) at a temperature range of from −80° C. to 150° C. and with a flow of N₂ gas at 60 mL/min, a heat quantity change was measured under a condition that the rate of temperature rise was 10° C./min for a temperature rise whereas the rate of temperature drop was 10° C./min for a temperature drop. DSC curves thus obtained are shown in FIGS. 1B, 3B, and 9A to 16B. Moreover, from the DSC curves, Ms temperature, heating value, Af temperature, heat absorbing value quantity were read and were shown in Tables 1 and 2 shown below.

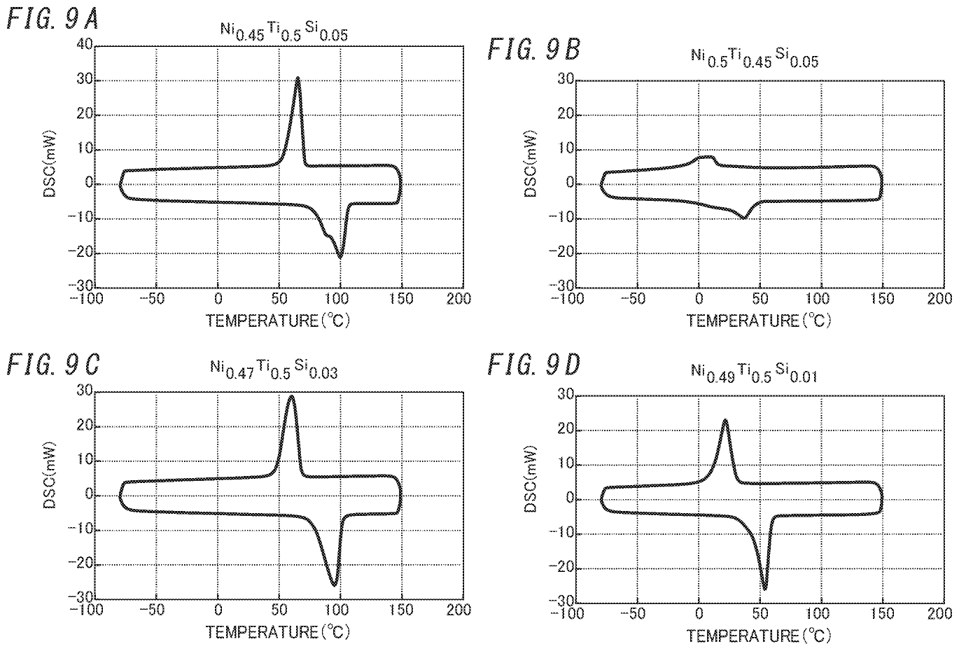

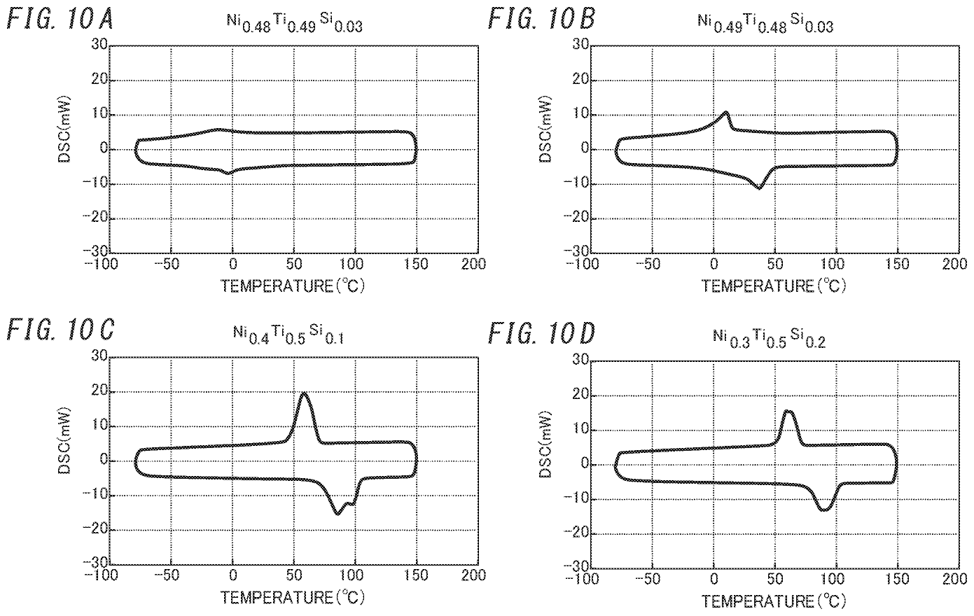

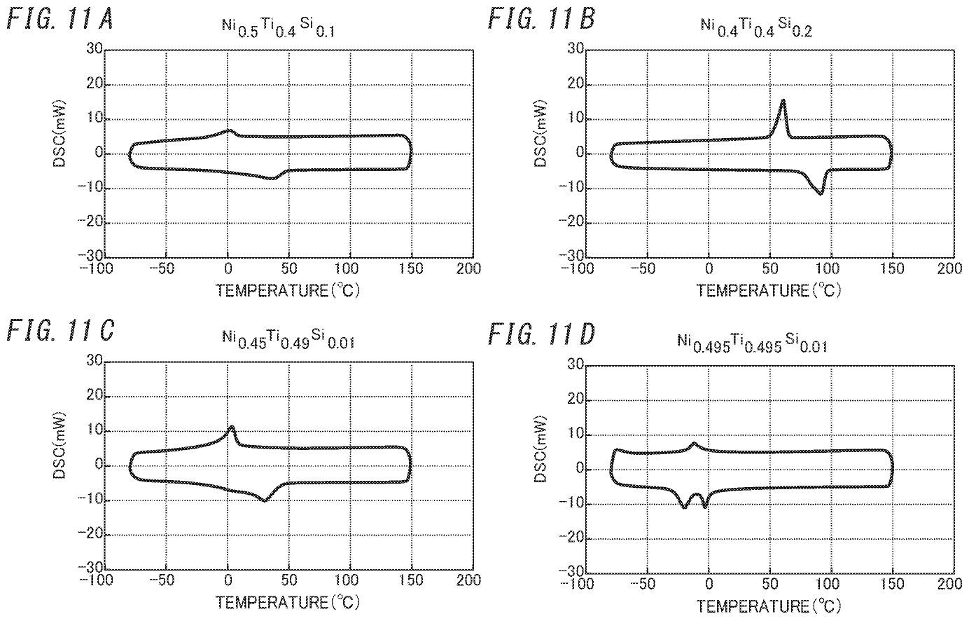

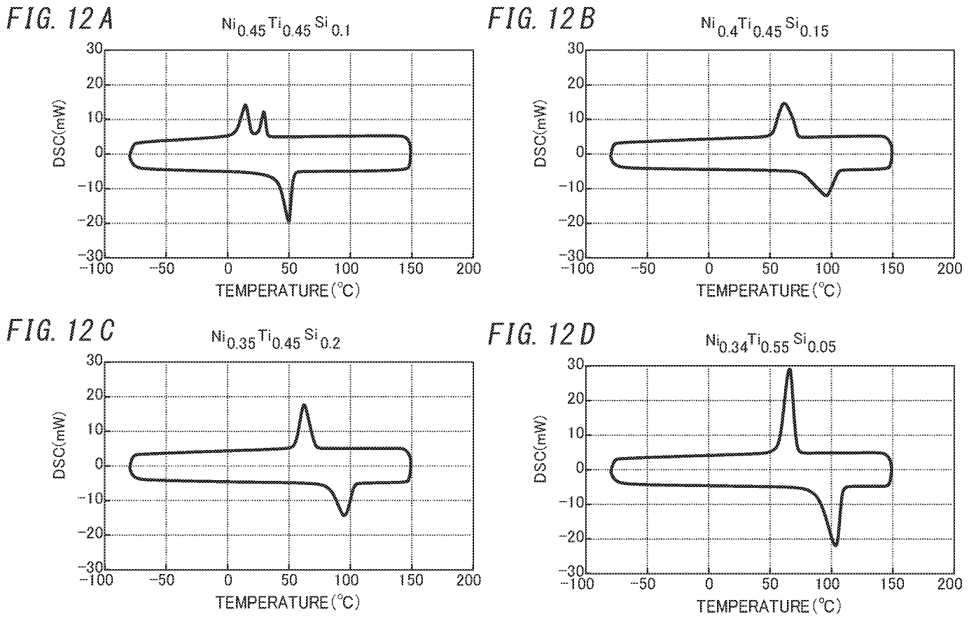

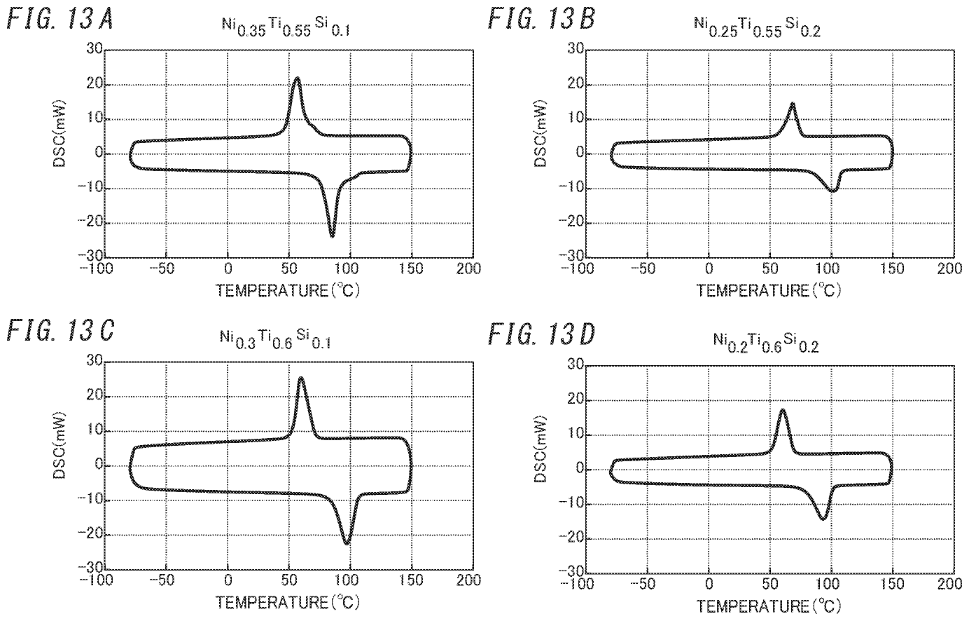

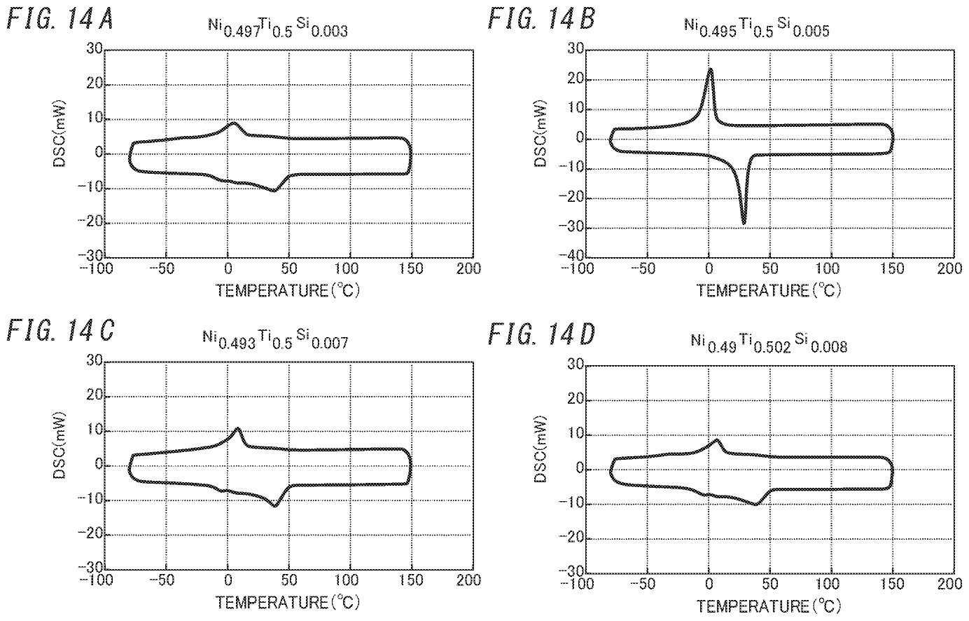

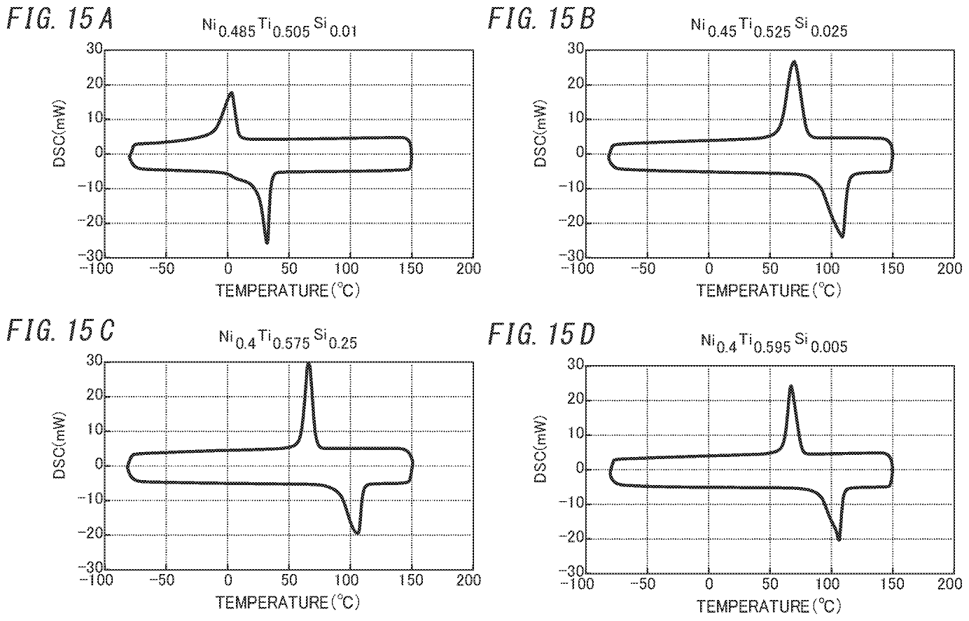

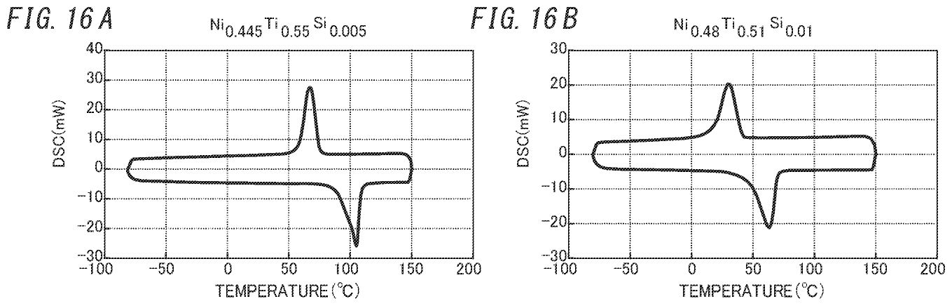

Note that FIGS. 9A to 9D are DSC curves of Examples 1 to 4, respectively. FIGS. 10A to 10D are DSC curves of Examples 5 to 8, respectively. FIGS. 11A to 11D are DSC curves of Examples 9 to 12, respectively. FIGS. 12A to 12D are DSC curves of Examples 13 to 16, respectively. FIGS. 13A to 13D are DSC curves of Examples 17 to 20, respectively. FIGS. 14A to 14D are DSC curves of Examples 21 to 24, respectively. FIGS. 15A to 15D are DSC curves of Examples 25 to 28, respectively. FIGS. 16A and 16B are DSC curves of Examples 29 and 30, respectively.

As results which are the DSC curves show, the Ni—Ti—Si alloys exhibited heat absorption reaction in a temperature rising process and exhibited heat generation reaction in a temperature lowering process in a similar manner to the Ni—Ti alloy (Ni:Ti=0.5:0.5) of Comparative Example 1 shown in FIG. 3B. This shows that the Ni—Ti—Si alloys of Examples 1 to 30 can perform repetitive heat-absorbing/generating reaction at a temperature cycle.

In particular, it was found that each of the Ni—Ti—Si alloys of Examples 1, 3, 4, 6, 7, 9, 10, and 13 to 30 shows a heating value higher than that of the Ni—Ti alloy of Comparative Example 1. Moreover, it was found that each of the Ni—Ti—Si alloys of Examples 1, 3, 4, 6, 7, 9, 10, 13 to 17, 19, and 20 to 30 shows a heat absorbing value higher than that of the Ni—Ti alloy of Comparative Example 1.

On the other hand, each of the Ni—Ti—Si alloys of Examples 2, 5, 8, and 11 resulted in a heating value lower than that of the Ni—Ti alloy of Comparative Example 1, indicating that at least either heat generation or heat absorption occurs at a temperature lower than that of the Ni—Ti alloy of Comparative Example 1. This indicates that heat absorption and heat generation can be implemented at a low temperature as compared with the Ni—Ti alloy.

(Stress-Strain Behavior)

For the alloy of Comparative Example 1 (Ni:Ti=0.5:0.5) produced as described above, a test specimen having a width of 3 mm, a length of 29 mm, and a thickness of 0.06 mm was produced, and the test specimen was subjected to a tension test by using a universal testing system (model number 5565 manufactured by Instron) under conditions that a measurement temperature was a room temperature, a maximum load was 185 N, and a pulling speed was 1 mm/min. Moreover, for the alloy of Example 9 (Ni:Ti:Si=0.4:0.5:0.1) produced as described above, a test specimen having a width of 2 mm, a length of 4 mm, and a thickness of 2 mm was produced, and the test specimen was subjected to a thermocompression test by using a precision universal testing machine (model number AGS-X manufactured by Shimadzu Corporation) under conditions that a measurement temperature was 110° C., a maximum load was 5 kN, and a compression speed was 0.5 mm/min. As results thus obtained, stress-deformation curves were shown in FIG. 1A (Example 9) and FIG. 3A (Comparative Example 1).

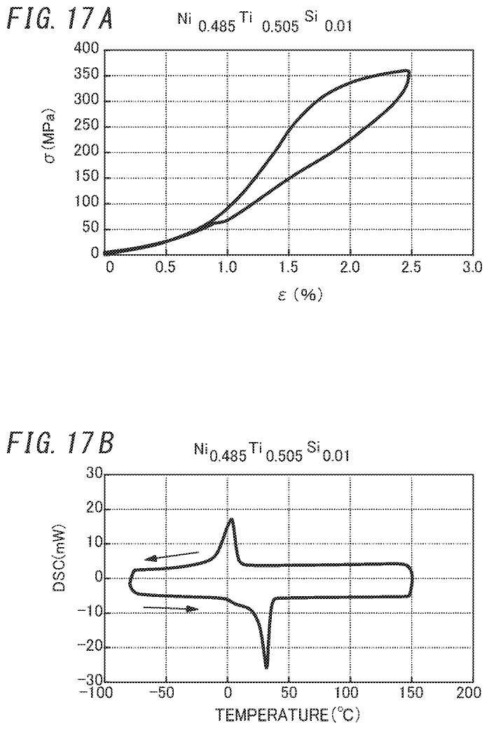

Moreover, for the alloy of Example 25 (Ni:Ti:Si=0.485:0.505:0.01) thus produced, a test specimen having a width of 2 mm, a length of 4 mm, and a thickness of 2 mm was produced, and the test specimen was subjected to a thermocompression test by using a precision universal testing machine (model number AGS-X manufactured by Shimadzu Corporation) under conditions that a measurement temperature was 40° C., a maximum load was 1.45 kN, and a compression speed was 0.5 mm/min. As a result thus obtained, a stress-strain curves is shown in FIG. 17A (Example 25).

As shown in FIG. 3A, the Ni—Ti alloy of Comparative Example 1 deforms as a load (stress) given to the Ni—Ti alloy increases, and thereby, the strain also increases, and the strain is maximum at about 3.5% at a stress of about 1000 MPa. From a time point at which the strain is about 3.5%, a load given to the Ni—Ti alloy is released, the stress thus decreases, and the strain also gradually decreases, and the Ni—Ti alloy thus deformed returns to almost its initial shape. However, as shown in FIG. 3A, also at the stress of 0 MPa, a strain (residual strain) of about 1.1% resided in the Ni—Ti alloy, and simply removing the load did not allow the Ni—Ti alloy to return to its initial shape. Note that the residual strain residing in the Ni—Ti alloy is eliminated by heating to at least 50° C., and the Ni—Ti alloy returned to its initial shape.

On the other hand, in the Ni—Ti—Si alloy of Example 9, as shown in FIG. 1A, as a load given to the Ni—Ti—Si alloy increases, the Ni—Ti—Si alloy deforms, and the strain gradually increases. Thus, the Ni—Ti—Si alloy exhibited superelasticity that the elastic limit is not reached even when the stress increases to about 1200 MPa and a strain of about 8.5% is caused, the strain also decreases as the stress gradually decreases, the strain gradually deceases to 0% when the stress is 0 MPa, and the Ni—Ti—Si alloy thus returns to its initial shape.

Moreover, in the Ni—Ti—Si alloy of Example 25, as shown in FIG. 17A, as a load given to the Ni—Ti—Si alloy increases, the Ni—Ti—Si alloy deforms, and the strain gradually increases. Thus, the Ni—Ti—Si alloy exhibited superelasticity that the elastic limit is not reached even when the stress increases to about 350 MPa and a strain of about 2.5% is caused, the strain also decreases as the stress gradually decreases, the strain gradually deceases to 0% when the stress is 0 MPa, and the Ni—Ti—Si alloy thus returns to its initial shape.

For the examples other than Examples 9 and 25, stress-strain curves similar to those of Examples 9 and 25 were obtained, indicating that the Ni—Ti—Si alloy exhibits an excellent superelasticity effect as compared with the Ni—Ti alloy.

Moreover, results of “DSC measurement (thermal behavior)” and “stress-strain behavior” show that the Ni—Ti—Si alloy allows phase transition in accordance with the stress, and heat absorption or heat generation occurs at the time of the phase transition. This indicates that the Ni—Ti—Si alloy exhibits an elastocaloric effect.

TABLE 1

| | | | | Ms Temperature | | Af Temperature | |
|---|---|---|---|---|---|---|---|
| | | | | (Martensite | | (Austenite | Heat |
| | Composition | | | Transformation | Heating | Transformation | Absorbing |
| | Ratio | | | Start | Value | End | Value |
| | Ni | Ti | Si | Temperature)[° C.] | [J/g] | Temperature)[° C.] | [J/g] |
| Comparative | 0.500 | 0.500 | 0.000 | 21.9 | 11.3 | 48.4 | 12.3 |
| Example 1 | | | | | | | |
| Examples 1 | 0.450 | 0.500 | 0.050 | 71.5 | 24.1 | 107.1 | 23.7 |
| Examples 2 | 0.500 | 0.450 | 0.050 | 17.9 | 8.6 | 47.4 | 12.3 |
| Examples 3 | 0.470 | 0.500 | 0.030 | 68.5 | 27.2 | 102.3 | 26.7 |
| Examples 4 | 0.490 | 0.500 | 0.010 | 30.5 | 23.6 | 59.5 | 24.3 |
| Examples 5 | 0.480 | 0.490 | 0.030 | 8.3 | 6.6 | 6.6 | 6.61 |
| Examples 6 | 0.490 | 0.480 | 0.030 | 49.9 | 14.4 | 49.4 | 15.9 |
| Examples 7 | 0.500 | 0.490 | 0.010 | 49.3 | 12.4 | 43.8 | 16.3 |
| Examples 8 | 0.495 | 0.495 | 0.010 | −0.7 | 3.3 | 4.9 | 10.3 |
| Examples 9 | 0.400 | 0.500 | 0.100 | 69.7 | 21.3 | 103.9 | 20.9 |
| Examples 10 | 0.300 | 0.500 | 0.200 | 72.1 | 13.2 | 104 | 13.2 |
| Examples 11 | 0.500 | 0.400 | 0.100 | 36.2 | 7.25 | 47.9 | 8.05 |
| Examples 12 | 0.400 | 0.400 | 0.200 | 65.7 | 9.25 | 96.6 | 9.08 |
| Examples 13 | 0.450 | 0.450 | 0.100 | 32.6 | 12.2 | 53.4 | 13.4 |
| Examples 14 | 0.400 | 0.450 | 0.150 | 72.7 | 13.7 | 106.3 | 13.8 |
| Examples 15 | 0.350 | 0.450 | 0.200 | 70.7 | 14.1 | 104.5 | 13.8 |
| Examples 16 | 0.400 | 0.550 | 0.050 | 72 | 25.1 | 109.8 | 24.6 |
| Examples 17 | 0.350 | 0.550 | 0.100 | 65.3 | 22.5 | 93.1 | 22.1 |
| Examples 18 | 0.250 | 0.550 | 0.200 | 75.8 | 11.6 | 107.4 | 11.1 |
| Examples 19 | 0.300 | 0.600 | 0.100 | 71.7 | 13.6 | 106.2 | 13.2 |
| Examples 20 | 0.200 | 0.600 | 0.200 | 70.1 | 16.7 | 101.8 | 16.1 |

TABLE 2

| | | | | Ms Temperature | | Af Temperature | |
|---|---|---|---|---|---|---|---|
| | | | | (Martensite | | (Austenite | Heat |
| | Composition | | | Transformation | Heating | Transformation | Absorbing |
| | Ratio | | | Start | Value | End | Value |
| | Ni | Ti | Si | Temperature)[° C.] | [J/g] | Temperature)[° C.] | [J/g] |
| Examples 21 | 0.497 | 0.500 | 0.003 | 51.3 | 12.3 | 51.2 | 16.6 |
| Examples 22 | 0.495 | 0.500 | 0.005 | 5.9 | 19.5 | 33.0 | 21.2 |
| Examples 23 | 0.493 | 0.500 | 0.007 | 50.2 | 13.2 | 50.9 | 17.9 |
| Examples 24 | 0.490 | 0.502 | 0.008 | 50.0 | 13.9 | 50.6 | 17.1 |
| Examples 25 | 0.485 | 0.505 | 0.010 | 8.4 | 18.9 | 35.5 | 20.7 |
| Examples 26 | 0.450 | 0.525 | 0.025 | 80.2 | 29.6 | 114.1 | 28.4 |
| Examples 27 | 0.400 | 0.575 | 0.025 | 71.6 | 19.9 | 110.6 | 19.1 |
| Examples 28 | 0.400 | 0.595 | 0.005 | 75.8 | 18.1 | 110.0 | 17.5 |
| Examples 29 | 0.445 | 0.550 | 0.005 | 74.9 | 24.8 | 109.1 | 24.0 |
| Examples 30 | 0.480 | 0.510 | 0.010 | 41.7 | 24.6 | 70.0 | 25.3 |

### SUMMARY

As described above, an Ni—Ti-based alloy of a first aspect of the present disclosure contains a Ni atom, a Ti atom, and a Si atom. The Ni—Ti-based alloy has a heat-absorbing/generating property.

With this aspect, a heat-absorbing property and a heat-generating property which are different from those of a Ni—Ti alloy are exhibited. Thus, the Ni—Ti-based alloy is appropriately applicable to a heat-absorbing/generating material and a heat exchange device, such as a heating device and a cooling device, having a heat exchanging function.

A Ni—Ti-based alloy of a second aspect referring to the first aspect has superelasticity.

With this aspect, the Ni—Ti-based alloy is easily applicable to a repetitively usable material.

In a Ni—Ti-based alloy of a third aspect referring to the first or second aspect, a ratio of the Si atom to a total amount of atoms in the Ni—Ti-based alloy is less than or equal to 50 at %.

With this aspect, a Ni—Ti—Si alloy has a heat-absorbing/generating property different from that of the Ni—Ti alloy. Moreover, in this case, the Ni—Ti—Si alloy can have superelasticity different from that of the Ni—Ti alloy.

In a Ni—Ti-based alloy of a fourth aspect referring to any one of the first to third aspects, a composition ratio of the Ni atom, the Ti atom, and the Si atom is, in a ternary graph which shows an atom % of the Ni atom on an x axis, an atom % of the Ti atom on a y axis, and an atom % of the Si atom on a z axis, within a range surrounded by a line segment connecting a point A having coordinates (50, 49, 1) and a point D having coordinates (50, 30, 20), a line segment connecting the point D and a point I having coordinates (20, 60, 20), a line segment connecting the point I and a point J having coordinates (30, 60, 10), a line segment connecting the point J and a point K having coordinates (40, 55, 5), a line segment connecting the point K and a point L having coordinates (49, 50, 1), a line segment connecting the point L and a point M having coordinates (49.5, 49.5, 1), and a line segment connecting the point M and the point A.

This aspect provides a Ni—Ti—Si alloy having a heat-absorbing/generating property different from that of the Ni—Ti alloy.

In a Ni—Ti-based alloy of a fifth aspect referring to any one of the first to third aspects, composition ratios of the Ni atoms, the Ti atoms, and the Si atoms are, in a ternary graph which shows the atom % of the Ni atoms on the x axis, the atom % of the Ti atoms on the y axis, and the atom % of the Si atoms on the z axis, within a range surrounded by a line segment connecting a point a having coordinates (49.7, 50, 0.3) and a point b having coordinates (49.5, 50, 0.5), a line segment connecting the point b and a point c having coordinates (49.3, 50, 0.7), a line segment connecting the point c and a point d having coordinates (49, 50.2, 0.8), a line segment connecting the point d and a point e having coordinates (48.5, 50.5, 1), a line segment connecting the point e and a point f having coordinates (45, 52.5, 2.5), a line segment connecting the point f and a point g having coordinates (40, 57.5, 2.5), a line segment connecting the point g and a point h having coordinates (40, 59.5, 0.5), a line segment connecting the point h and a point i having coordinates (44.5, 55, 0.5), and a line segment connecting the point i and the point a.

This aspect provides a Ni—Ti—Si alloy having a heat absorbing/heating value higher than that of the Ni—Ti alloy.

A heat-absorbing/generating material (1) of a sixth aspect contains the Ni—Ti-based alloy of any one of the first to fifth aspects.

With this aspect, a heat-absorbing property and a heat-generating property which are different from those of a Ni—Ti alloy are exhibited. Thus, the heat-absorbing/generating material is appropriately applicable to a heat exchange device, such as a heating device and a cooling device, having a heat exchanging function.

A heat-absorbing/generating material (1) of a seventh aspect referring to the sixth aspect further contains a mixed component (2).

With this aspect, heat is more easily taken out of the heat-absorbing/generating material (1) and is more easily absorbed by the heat-absorbing/generating material (1).

A Ni—Ti-based alloy production method of an eighth aspect includes a mixing step and an arc discharge step. The mixing step includes mixing Ni powder, Ti powder, and Si powder together to obtain a mixture. The arc discharge step includes subjecting the mixture to an arc discharge under an inert gas atmosphere.

This aspect easily provides a Ni—Ti—Si alloy having an excellent elastocaloric effect and an excellent heat-absorbing/generating property. Moreover, with this production method, atoms which can be included in the Ni—Ti—Si alloy are easily uniformly mixed together as compared with a production method employing solid phase reaction.

A heat exchange device (200) of a ninth aspect includes a heat-absorbing/generating member (100) and a housing member (110) in which the heat-absorbing/generating member (100) is housed. The heat-absorbing/generating member (100) includes the heat-absorbing/generating material (1) of the sixth or seventh aspect.

With this aspect, taking advantages of the elastocaloric effect of the heat-absorbing/generating material (1) resulting from a change in stress caused by a load, for example, by applying the load to the heat-absorbing/generating material (1) and removing the load from the heat-absorbing/generating material (1) enables a heat exchanging mechanism in the heat exchange device (200) to be implemented.

A heat exchange device (200) of a tenth aspect referring to the ninth aspect further includes a first support member (201) and a second support member (202). A heat-absorbing/generating member (100) lies between the first support member (201) and the second support member (202) and is configured to be deformable in response to a load received from at least one of the first support member (201) or the second support member (202).

With this aspect, a heat exchange device (200) having a further excellent heat efficiency is implemented.

### REFERENCE SIGNS LIST

1 Heat-Absorbing/Generating Material
2 Mixed Component
100 Heat-Absorbing/Generating Member
110 Housing Member
120 Heat Medium
200 Heat Exchange Device
201 First Support Member
202 Second Support Member

1. An Ni—Ti-based alloy comprising:
a Ni atom;
a Ti atom; and
a Si atom,
the Ni—Ti-based alloy having a heat-absorbing/generating property.

2. The Ni—Ti-based alloy of claim 1, having superelasticity.

3. The Ni—Ti-based alloy of claim 1, wherein
a ratio of the Si atom to a total amount of atoms in the Ni—Ti-based alloy is less than or equal to 50 at %.

4. The Ni—Ti-based alloy of claim 1, wherein
a composition ratio of the Ni atom, the Ti atom, and the Si atom is, in a ternary graph which shows an atom % of the Ni atom on an x axis, an atom % of the Ti atom on a y axis, and an atom % of the Si atom on a z axis, within a range surrounded by a line segment connecting a point A having coordinates (50, 49, 1) and a point D having coordinates (50, 30, 20), a line segment connecting the point D and a point I having coordinates (20, 60, 20), a line segment connecting the point I and a point J having coordinates (30, 60, 10), a line segment connecting the point J and a point K having coordinates (40, 55, 5), a line segment connecting the point K and a point L having coordinates (49, 50, 1), a line segment connecting the point L and a point M having coordinates (49.5, 49.5, 1), and a line segment connecting the point M and the point A.

5. The Ni—Ti-based alloy of claim 1, wherein
a composition ratio of the Ni atom, the Ti atom, and the Si atom is, in a ternary graph which shows an atom % of the Ni atom on an x axis, an atom % of the Ti atom on a y axis, and an atom % of the Si atom on a z axis, within a range surrounded by a line segment connecting a point a having coordinates (49.7, 50, 0.3) and a point b having coordinates (49.5, 50, 0.5), a line segment connecting the point b and a point c having coordinates (49.3, 50, 0.7), a line segment connecting the point c and a point d having coordinates (49, 50.2, 0.8), a line segment connecting the point d and a point e having coordinates (48.5, 50.5, 1), a line segment connecting the point e and a point f having coordinates (45, 52.5, 2.5), a line segment connecting the point f and a point g having coordinates (40, 57.5, 2.5), a line segment connecting the point g and a point h having coordinates (40, 59.5, 0.5), a line segment connecting the point h and a point i having coordinates (44.5, 55, 0.5), and a line segment connecting the point i and the point a.

6. A heat-absorbing/generating material comprising the Ni—Ti-based alloy of claim 1.

7. The heat-absorbing/generating material of claim 6, further comprising a mixed component mixed with the Ni—Ti-based alloy.

8. A Ni—Ti-based alloy production method comprising:
a mixing step including mixing Ni powder, Ti powder, and Si powder to obtain a mixture, and
an arc discharge step including subjecting the mixture to an arc discharge under an inert gas atmosphere.

9. A heat exchange device comprising
a heat-absorbing/generating member; and
a housing member in which the heat-absorbing/generating member is housed,
the heat-absorbing/generating member including the heat-absorbing/generating material of claim 6.

10. The heat exchange device of claim 9, further comprising:
a first support member; and
a second support member, wherein
the heat-absorbing/generating member lies between the first support member and the second support member and is configured to be deformable by receiving a load from at least one of the first support member or the second support member.
